(19) United States
(12) Patent Application Publication
(10) Pub. No.: US 2025/0378745 A1
(43) Pub. Date: Dec. 11, 2025

(54) Method And System For Wagering And Fantasy Sports For A Synchronized Shared Viewing Experience

(71) Applicant: BigUp, Inc., Brooklyn, NY (US)

(72) Inventors: Arjun Varman BALASINGAM, New York, NY (US); Ali Airaj AHSAN, Brooklyn, NY (US)

(21) Appl. No.: 19/233,356

(22) Filed: Jun. 10, 2025

Related U.S. Application Data
(60) Provisional application No. 63/658,073, filed on Jun. 10, 2024.

(51) Int. Cl. G07F 17/32; G06Q 50/34

(52) U.S. Cl. CPC G07F 17/3288; G06Q 50/34; G07F 17/323; G07F 17/3244

(57) ABSTRACT

A method includes establishing a co-watching session at a host device for a streaming event, joining the co-watching session at a first user device, joining the co-watching session at a second user device, establishing a first account balance associated with the first user device, establishing a second account balance associated with the second user device, initiating a wager display interface for a wager during the co-watching session, generating a selection signal for selecting the wager at the second user device and reducing the second account balance based on the selection signal.

### CROSS-REFERENCE TO RELATED APPLICATION

The application claims priority to U.S. Provisional Application 63/658,073 filed on Jun. 10, 2024. This application is related to U.S. Non-provisional application Ser. No. 19/198,696 filed on May 5, 2025. The entire disclosures of the above applications are incorporated herein by reference.

### FIELD

The present disclosure relates to video content, and, more particularly, to a system and method for wagering and fantasy sports during a synchronized presentation of video content and associated data from different sources to a plurality of user devices.

### BACKGROUND

This section provides background information related to the present disclosure which is not necessarily prior art.

Watching a video content with others allows a shared experience with a group. In the past, people would gather in a single spot such as a home or restaurant with friends to enjoy a particular content such as a sporting event. Broadcasted events happen at various times. However, recreating the shared experience across a wider geographic area is desirable.

Currently co-watching from centralized content providers who can directly control delivery of content is known. Netflix® and Twitch® have watch parties that provide a single piece of content that users can watch simultaneously.

There are challenges to co-watching in that some events are broadcasted by different providers in different locations of the world. Different media providers may have different timings especially when commercial breaks interrupt a broadcast.

Fantasy sports and betting are popular in sporting events. Providing the ability to wager during a synchronized viewing experience is not known.

### SUMMARY

This section provides a general summary of the disclosure, and is not a comprehensive disclosure of its full scope or all of its features.

The present system allows people distributed around the world to watch the same content together synchronously regardless of graphics, commentators, ad breaks, and the like.

Some features of the present disclosure include daily fantasy sports, daily fantasy sports with wagering, synchronized experiences with a single sportsbook for wagering, synchronized experiences with multiple sportsbooks for wagering, the synchronized system as the sportsbook, and peer-to-peer wagering. Wagers may vary in denomination and may be made in currency, tokens, virtual currency or points. Multiple wagers may be associated with a live co-watching stream. Wagers are made with non-negative values with the goal of determining a winner, a balance and/or a reputation.

A wager event may be initiated at various devices within the system including the host device or host server, co-watching session client devices.

The wagering event may be initiated outside of the co-watching session, even though the wagering itself occurs during the co-watching session. For example, the sportsbook sets up the wagering event with a number of potential wagers, and during the co-watching session a user can wager on those wagers that were already set up in advance. In another example, the co-watching session host could set up the wagering event (e.g., fantasy competition) before going live, so that participants could configure their fantasy teams prior to the co-watching event itself.

In one aspect of the disclosure, a method includes establishing a co-watching session at a host device for a streaming event, joining the co-watching session at a first user device, joining the co-watching session at a second user device, establishing a first account balance associated with the first user device, establishing a second account balance associated with the second user device, initiating a wager display interface for a wager during the co-watching session, generating a selection signal for selecting the wager at the second user device and reducing the second account balance based on the selection signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a high level block diagrammatic view of the system architecture.

FIG. 1B is a flowchart of a high-level method for implementing a game.

FIG. 2A is a flowchart for creating daily fantasy sports.

FIG. 2B is a screen display for creating a fantasy competition.

FIG. 2C is a screen display for establishing a fantasy competition.

FIG. 2D is a screen display for a user device for picking a team for a fantasy competition.

FIG. 2E is a screen display with a player selection for the fantasy competition.

FIG. 2F is a screen display for a selected team.

FIG. 2G is a screen display for the payment method for the daily fantasy competition.

FIG. 2H is a screen display illustrating a successful submission.

FIG. 2I is a screen display showing a leaderboard for the daily fantasy competition.

FIG. 2J shows a main display for a chat area.

FIG. 2K is a screen display showing the winner of a fantasy sports competition.

FIG. 3A is a flowchart of a method for wagering using a single sportsbook.

FIG. 3B is a screen display for presenting a wager.

FIG. 3C is a screen display for entering a wager.

FIG. 3D is a screen display illustrating an amount to wage.

FIG. 3E is a screen display for redirection to a sportsbook.

FIG. 4A is a flowchart of a method for using multiple sportsbooks in a wagering process.

FIG. 4B is a screen display for initiating a bet.

FIG. 4C is a screen display for initiating a wager based on the bet.

FIG. 4D is a screen display illustrating selections of a sportsbook.

FIG. 4E is a screen display for selecting a wager amount.

FIG. 4F is a screen display for redirection to a sportsbook.

FIG. 5A is a flowchart of a method for using the system server as the sportsbook.

FIG. 5B is a screen display for communicating a successful wager with the system server as the sportsbook.

FIG. 6A is a flowchart of a method for peer to peer wagering.

FIG. 6B is a screen display for creating a peer to peer wager.

FIG. 6C is a screen display for creating a peer to peer wager.

FIG. 6D is a screen display illustrating a successful wager creation.

FIG. 6E is a screen display for a user device displaying a potential wager.

FIG. 6F is a screen display for selecting an amount to wager.

FIG. 6G is a screen display indicating a wager is successful.

FIG. 7A is a flowchart of a method for generating a free to play daily fantasy sports competition.

FIG. 7B is a screen display for entering a daily fantasy sports competition that is free to play.

FIG. 8A is a flowchart of a method for a daily fantasy sports system using platform tokens or platform currency rather than actual currency.

FIG. 8B is a screen display for entering a community fantasy sports competition using tokens.

FIG. 9A is a flowchart of a method for using the session server as a sportsbook.

FIG. 9B is a screen display illustrating a successful wager for the method of FIG. 9A.

Corresponding reference numerals indicate corresponding parts throughout the several views of the drawings.

### DETAILED DESCRIPTION

Example embodiments will now be described more fully with reference to the accompanying drawings.

In the following figures, the viewer refers to a user device associated with a viewer and the host refers to the host device.

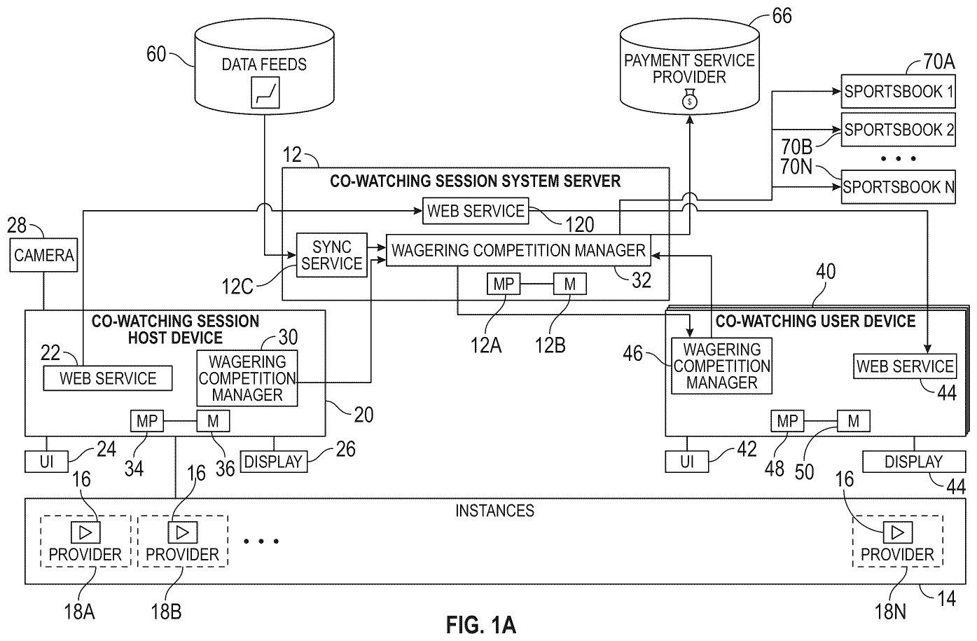

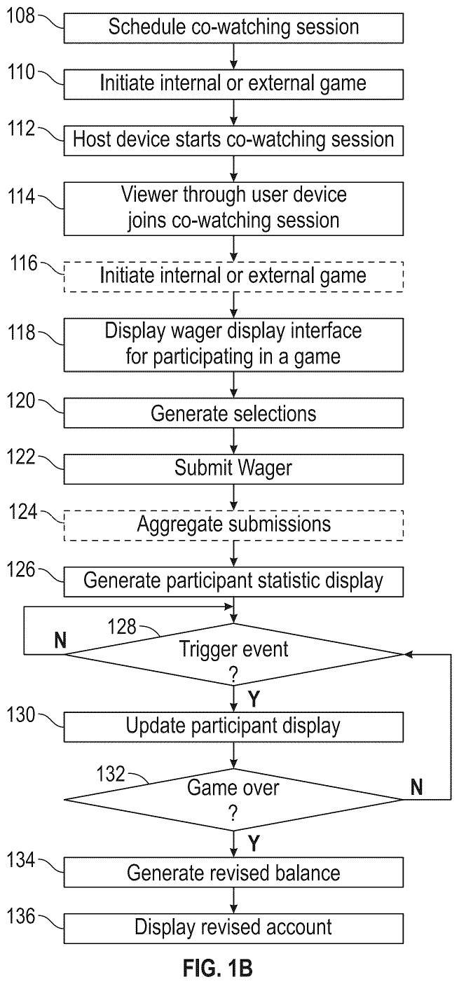

Referring now to FIG. 1A, a system architecture diagram for a co-watching and wagering system or simply system 10 is set forth illustrating various aspects of the disclosure. The system 10 has a co-watching session server 12 and a host system device 20.

The session server 12 has a microprocessor 12A and a memory 12B that are used to control the method set forth below. The microprocessor 12A may be referred to as a processor. The memory 12B may be non-transitory computer-readable medium that includes instructions that are executable by the microprocessor 12A. The instructions may include instructions for controlling the various methods as set forth below. The memory 12B may be used for storing various data including, but not limited to, wager account balances associated with each user device 40.

The host device 20 may be implemented as a server that has access to various instances 14 of a broadcasted video signals 16 from different broadcast providers 18A-18N. The broadcasted video signals may be a streamed signal through the Internet. The system 10 establishes a co-watching session service that has a co-watching session for multiple user devices.

A host device 20 initiates a co-watching session for the broadcasted content. The session may be started by the host device 20 at the time of the broadcast or some time period before the broadcast. In the present examples, establishing the co-watching session allows for pre-broadcast wagers to be established. A co-watching session is an event where two or more people assemble together virtually over the Internet through an application. The event could be private or open to the public. A designated host initiates the co-watching session that goes live at a particular time.

The co-watching session host device 20 broadcasts video, audio, text commentary or combinations thereof of themselves, while the host device and all participant user devices 40 consume the same piece of content (e.g., video, audio) served either externally or by the co-watching platform. The commentary in the co-watching session will generally be related to content, though it could touch on other topics. The host device 20 may block certain inappropriate content or users who engage in inappropriate use of the service.

The host device 20 may also initiate a game which is a competition. The game may be initiated before or during a livestream. Different types of games may be initiated including but not limited to daily fantasy sports, sports betting, “pick 'em” type games, predictions and trivia.

Before the content is broadcasted, viewers of the co-watching session may engage in discussion with each other over chat from the client device. Host devices can bring on co-hosts or other viewers as guests to join them in leading the discussion. Chat may occur after the broadcast has finished.

Synchronization of commentary and data may be synchronized by a sync service 12C that synchronizes because the video content sources may be somewhat offset. The system server determines offsets of each for the video streams as compared to a reference stream. A host device establishes the session in communication with the system server. Clients join a session at a user device and apply an offset based on the provider being streamed to the particular client user device.

The co-watching session host device 20 may include a web service 22 that is used for communicating with a web service 12D of the co-watching session system server 12. The co-watching session host device 20 may also include a user interface 24 that allows the host using the host device 20 to enter various inputs and control the overall system process and flows. The user interface 24 may be but is not limited to a keyboard, a mouse, button or a touch screen. The host device 20 may also include a display 26 that is used for displaying various events and the like. A camera 28 may be used for streaming and generating both video and audio. Of course, a microphone may replace the camera to provide only audio.

A wagering competition manager 30 is used to initiate community wagering events and entering data associated with betting and wagering. The host device 20 has a microprocessor 34 and a memory 36 that are used to control the method set forth below. The microprocessor 34 may be referred to as a processor. The memory 36 may be non-transitory computer-readable medium that includes instructions that are executable by the microprocessor 34. The instructions may include instructions for controlling the various methods as set forth below.

The user devices 40 may each include a user interface 42 and a display 44 for receiving and displaying various screen displays. The user interface 42 may be a number of types of user interfaces, such as buttons, a keyboard, a mouse or a touch screen used for selecting various data for making wagers. The user device communicates with the system server 12 using a web service 45. A wagering competition manager 46 is used for generating and establishing wager competitions and is in communication with the wagering competition manager 32 of the co-watching session system server 12. The user device also includes a microprocessor 48 and a memory 50. The microprocessor 48 may be referred to as a processor and is coupled to the memory 50 which may be a non-transitory computer-readable medium that includes instructions that are executable by the processor. The instructions may include instructions for performing various functions of the user device including forming bets and wagers.

The wagering competition managers 30, 32 and 46 may all intercommunicate with a data feed 60. The data feed 60 may provide lineups and real time statistics such as score updates to the system server 12 and in particular to the wagering competition manager 32. The wagering competition manager 30 may receive initiation signals to establish a community wagering event from the competition manager 30. The wagering competition manager 32 may provide wagering event details to the wagering competition manager 46. These may include the lineups, the amounts of the wager, odds and relative scores to other users in a leaderboard or the like as described in greater detail below. The wagering competition manager 46 may allow submissions of a wager from each of the user devices.

The wagering competition manager 32 may also be in communication with a payment service provider 66 that allows payments to be made to the winners of a wager and receive payments from the user devices that are competing. The wagering competition manager 32 may also increase account balances internal to the system server 12 within the payment provider 66 for wager won or reduce account balances for wager lost. In summary, the wagering competition manager 32 revises account balance whether at the payment service provider 66 or the within the system server 12.

The system server 12 may act as a sportsbook. The sportsbook allows odds to be determined and the wagers to be placed. However, one or more external sportsbook servers 70A, 70B through 70N (simply sportsbooks) may be provided. By providing a plurality of sportsbook servers, different sportsbooks may be considered for the placement of a wager by the user devices 40. Selection criteria may include the previous establishment of an account at a sportsbook. However, other criteria such as odds.

Referring now to FIG. 1B, a method for implementing a game is set forth. In the following figures data may be exchanged through a network between user devices, host device and the server system in order to form displays. The game, in this method, is initiated by a host device and allows users to join the game. A co-watching session is initiated or created when scheduled. Scheduling occurs before the co-watching stream is initiated as set forth in step 108. The users volunteer a wager to join the game. The wager may be merely an entry fee or an entry fee plus a specific wager that correspond to various events within a livestream. The initiation of a game may be performed in step 110 any time after scheduling the co-watching session including before the co-watching stream goes live by the host starting the live stream. The game may be an external game or an internal game meaning that the game may be provided through one of the sportsbooks 70A-70n or may be initiated or instituted at the system server 12. In step 110, the game is shown as being initiated prior to a co-watching session. However, as described below, the game may be initiated after the start of a co-watching session. As well, multiple games may be associated with a co-watching session. In step 112, the host device initiates or starts a co-watching session. In step 114, a viewer through a user device joins the co-watching session. However, should the game be initiated prior to the co-watching session, the co-watching session does not need to be joined in order to wager or join the game. In step 116, when step 110 is not performed prior to the starting of a co-watching session, the game is initiated after the start of the co-watching session. As mentioned above, the game may be an internal or external game relative to the system server. In step 118, a wager display interface may be displayed at a user device 40. The user device may be used to enter a wager. As mentioned above, the wager may be merely an entry fee or may be another type of wager that includes various types of betting including multiple wagers or combinations thereof.

In step 120, the user device generates selections as selection data, such as but not limited to team members, scores and various other options for the game. In step 122 the wager is submitted. In step 124, the system server may aggregate the submissions. Aggregation of submissions may be stored within the memory 12B of the system server 12. In step 126, a participant's statistic display may be generated and display at each of the user devices 40 that are participating in the game. This may be a sub screen or additional tab available during the co-watching session.

In step 128, the system server 12 looks for a trigger event. If no trigger event is found, step 128 repeats. When step 128 does find a trigger event, step 130 updates the display of the participants based upon the trigger event. One example of a participant display is a leaderboard that displays the leader for a multiple trigger event type wager. After step 130, step 132 determines whether the game is over. When the game is not over in step 132, step 128 looks for another trigger event. In step 132 when the game is over, step 134 generates a revised balance for each participant. This may reduce the amount of funds available for non-winning users. In step 134, when a user does win the game, the account balance may be revised upward. In step 136, a revised account display is generated for each of the user devices. Revenue from the game may be split using a revenue sharing model between the platform operator (system server) and the host device. In general, the data may be sent by way of the network to each user device.

In the following description sample games are described in greater detail. The games are associated with a co-watching stream and a host of the co-watching session initiates or anchors the competition. As mentioned above, the games may be initiated before the co-watching session is started. More than one game may be associated with a co-watching session. Monetary prizes may be given such as cash, a prize giveaway, gift cards, points, in-platform currency, credits and the like. The amount of the prizes may vary depending on various factors including the number of participants. Specific examples of games such as daily fantasy sports are provided below. Further, an example of another user initiating a wager is also set forth.

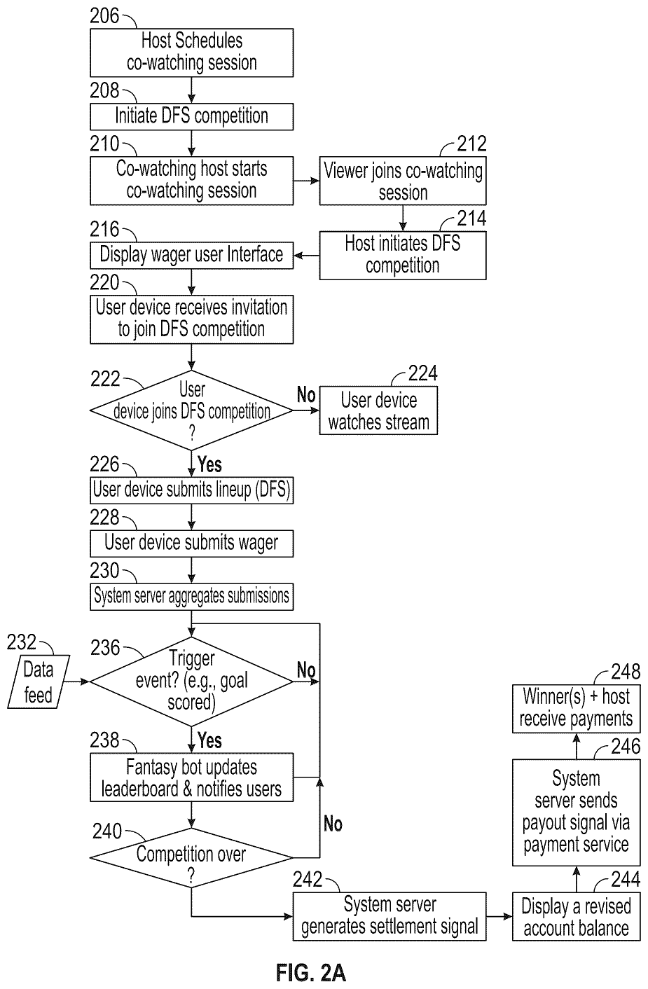

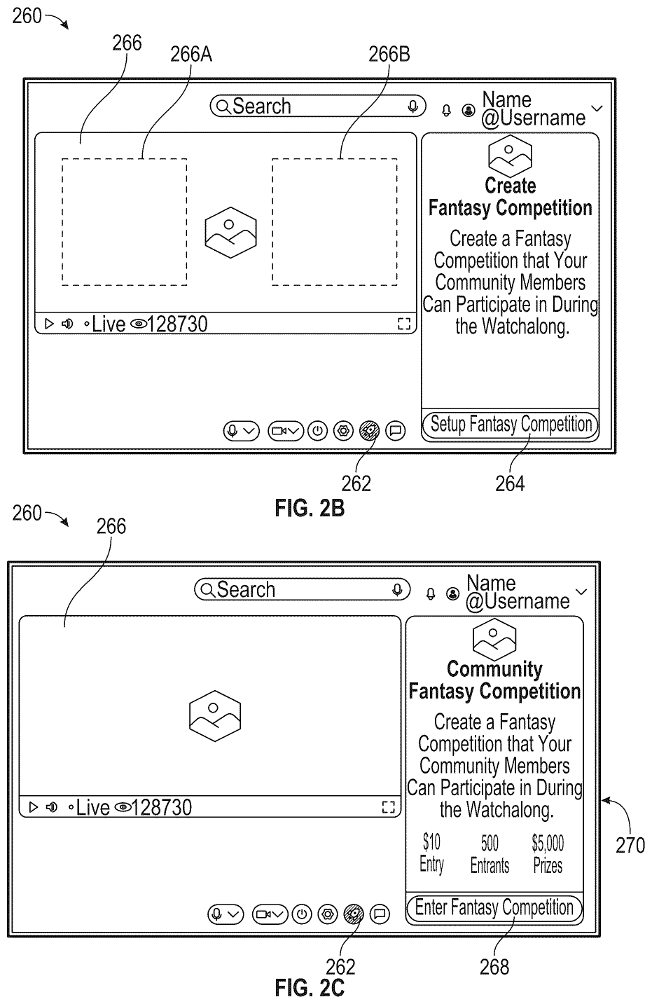

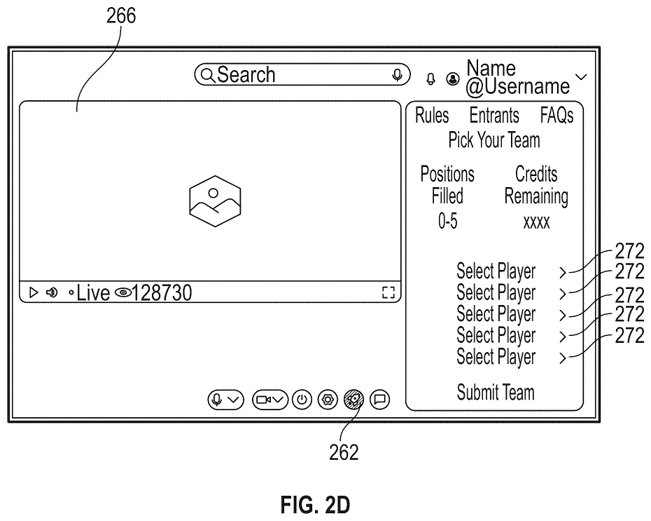

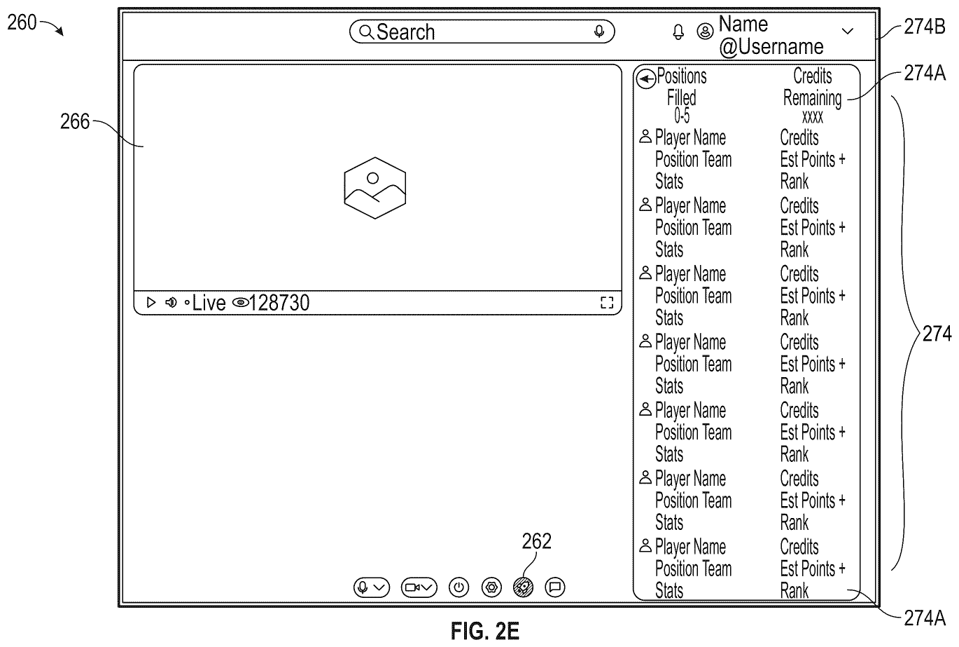

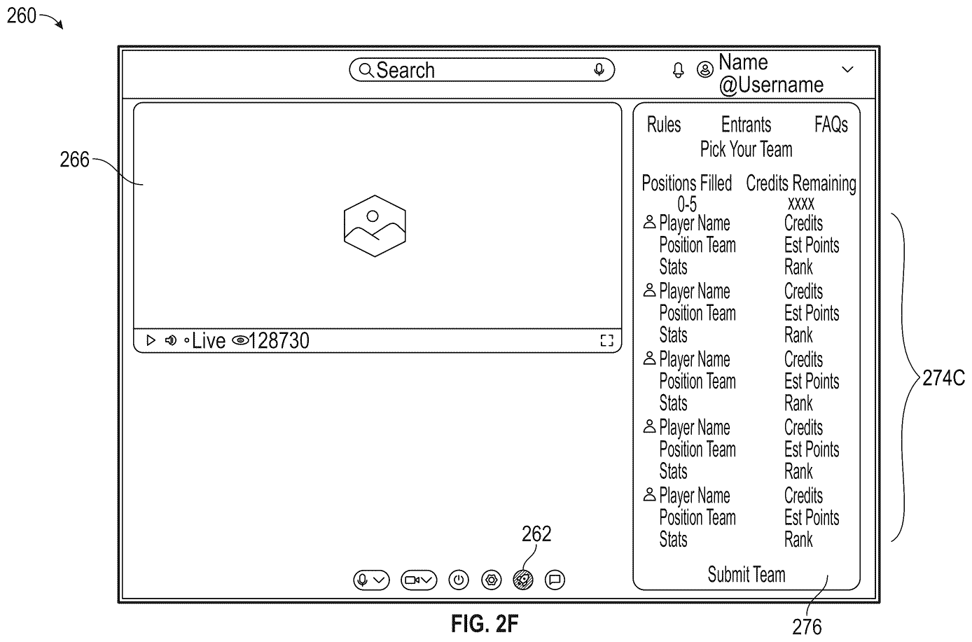

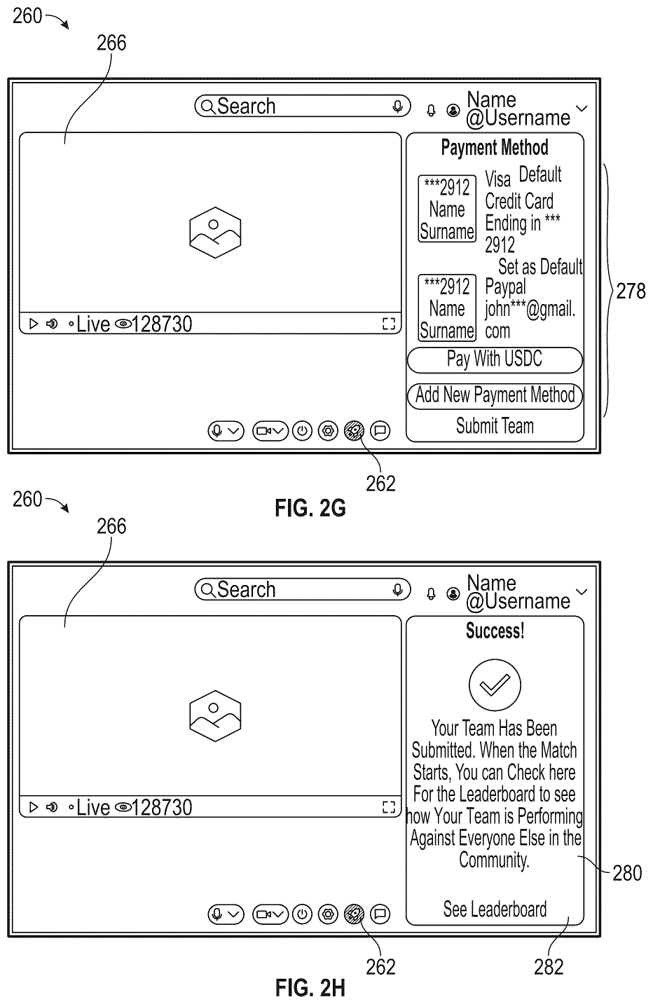

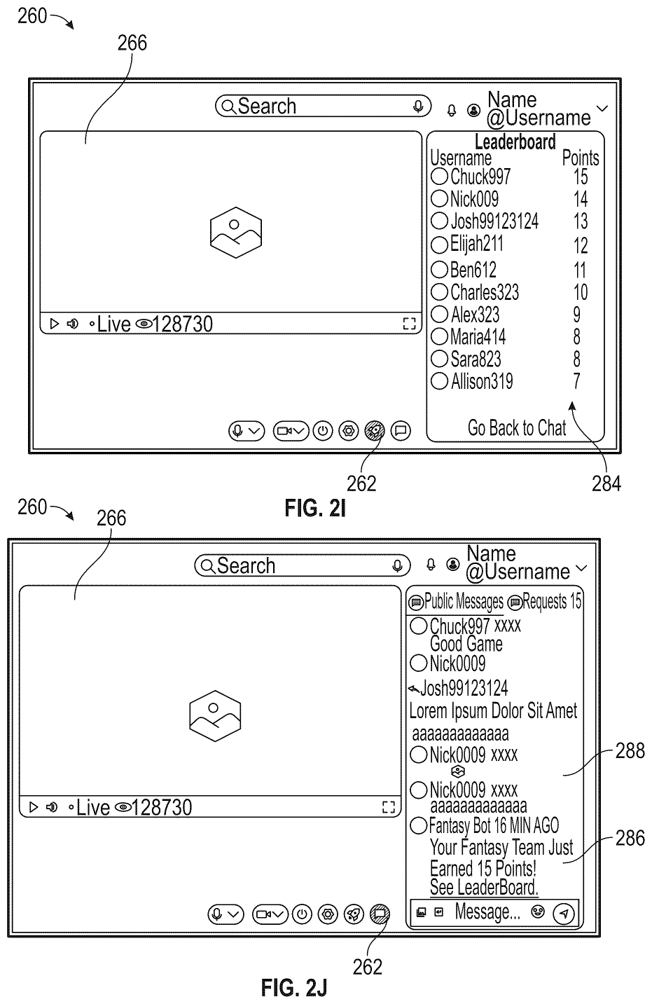

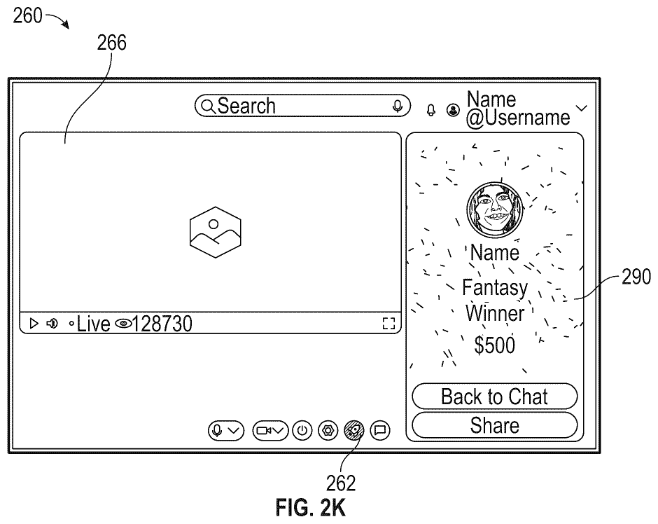

Referring now to FIGS. 2A through and 2K, a flowchart of a method for performing daily fantasy sports (DFS) as the game is set forth. In step 206, the host schedules a co-watching session. In step 208, the game such as the DFS competition may be optionally started before the co-watching session goes live (or after the co-watching session starts in 214 as set forth below). In step 210 the host starts a co-watching session. In step 212, a viewer user device joins the co-watching session. The joining of the co-watching session may be initiated through the web service of both the user device 40 and the co-watching session server 12. The host initiates a daily fantasy sports competition in step 214. An example of a community daily fantasy sports session is set forth below. In step 216, a wager user interface is displayed. The wager user interface allows various user devices to interact and place wagers according to limitation data set forth by the host. In step 220, a user device receives an invitation to join a daily fantasy sports competition. In step 220, a user device joins the daily sports competition by sending a joining signal to the waging competition manager. In step 224, if the viewer elects not to join the daily fantasy sports, the user device may merely watch the co-watching stream.

In step 226, the user device forms a daily fantasy sports team by selecting a line-up. In step 228, a wager may be placed by generating a wager signal and communicating the wager signal along with the line-up to the waging competition manager. In step 230, the session server 12 aggregates the submissions so that a comparison may be performed. In step 232, data is fed to determine a trigger event in step 236 after step 230. If no trigger event is performed, step 236 is continually performed. The triggering events may be various types of trigger events including a goaling score, penalties and the like. The triggering events may vary based upon the type of sports for the daily fantasy sport system. When a trigger event is determined in step 236, step 238 initiates a fantasy bot that updates a leaderboard and notifies user devices by notification signals. The notification signals may include the transmission of the leaderboard that may be monitored at the user devices. In step 240, when the competition is not over, step 236 is performed. In step 240, when the competition is over, the co-watching platform may generated a settlement signal in step 242. In step 244, a revised account balance for each of the participating user devices may be revised. In step 246, a co-watching platform sends out a payout signal via a payment service provider. The payment service provider may be a separate entity as illustrated above or may be part of the session system server described above.

In step 248, the winners and the user devices corresponding thereto may receive the payments from the system as well as the host receiving payments from the system as a fee signal.

In FIGS. 2B to 2G screen displays for an application or browser are set forth. The screen displays form a user interface in the operation of establishing a fantasy sports and wagering environment. Stages of a screen display displayed on one of the user devices having a wager display interface or screen display 260 is set for selecting and making wagers and selecting data and amounts for making wagers. Settlement signals are generated after the wagered event to provide updated account balances based on the wagers. A plurality of screen display that are interactive interfaces for performing various function in various scenarios are set forth. Data is communicated back and forth between the user devices and the system server to form the screen displays.

In FIG. 2B before starting a live stream, or during the live stream, a streamer or host device 20 is able to create a daily fantasy competition for user devices. To do so, the streamer (co-watching session client) or host device clicks on the activity button 262. Clicking opens the window 264 on the right side of the screen display which allows a host device to control configuring the details for the daily fantasy competition.

Co-watching client user devices 40 will be able to choose from various types of daily fantasy sports (DFS) competitions that host device 20 or server offers. In addition, the host device 20 will be able to set the entrance price that every viewer will need to pay in order to participate in the competition. The total prize money for each DFS competition may be fixed a priori or may be determined based on the number of participants that join each competition during the stream.

A stream in this case refers to a co-watching session. The live stream that happens during a live sporting event; the live sporting event may not be something hosted by the host device 20 or the system server 12. That is, the video signal may be separately communicated and integrated into a web browser display area 266 or a separate computer window may display the streaming event. By way of example, the display area 266 may have a host display area 266A which is a live video stream and a live event display area 266B that consists of the video stream.

In FIG. 2C, the user devices will be able to join a DFS competition after a streamer or host has created the competition by selecting a virtual button 268 on the screen display 260. A limit area 270 shows the limits for the DFS competition. In this example, there is an entry fee area ($10 fee), an entrant number (max 500 entrants) and a prize area showing the maximum available prize money ($5000). However, as mentioned above, the data values may change and points, credits or tokens may be used instead of dollar amounts. While the designs show that viewers can join the DFS competition from inside the stream itself, that does not imply that they will not be able to do so from other sections of the host website or other websites that partner with the host in the future.

In FIGS. 2D and 2E, there are multiple types of DFS competitions. The present example shows one type of DFS competition. In this example, the DFS competition requires viewers to create a team of 5 players by selecting virtual viewer buttons 272. The five players are selected from a roster of players 274 that are playing in the match that the stream is centered around. Data may be generated from the host or received from the data feed and may include some statistics in each player selector box 274A. For example, if the stream is a co-watching session for a Detroit Lions vs New York Jets game, viewers through their associated devices would be able to pick players from both teams to create their DFS team. In the example shown, each player would cost points/credits/money to add to a viewer's DFS team.

Each viewer builds a DFS team which may be limited in terms of a number of points/credits/money. The points/credits/money may be denominated differently from the currency left to wager. In the example shown, that number of points is 50,000 shown in the credits display 274B. While selecting the DFS team, the viewer is able to look at relevant statistics inside provided through the host server that can aid them when selecting which players to add to the roster.

In FIG. 2F, after selecting the players for their team, the viewer can submit their DFS team in the selected player boxes 274C to join the competition by selecting the selection box 276 which generates a selection signal. Selection signals are communicated to the host device 20 from each of the user devices 40 associated with a viewer.

In FIG. 2G, before entering the competition, viewers will need to pay the entrance fee for the competition by selecting a payment virtual button 278. Viewers can pay through their credit/debit cards, any electronic payment service provider such as PayPal™ or through cryptocurrencies that the host server accepts.

In FIG. 2H, once a viewer's payment is successful, their team is entered into the competition and a success indicator 280 may be displayed. To redirect the viewer to a leaderboard, a leaderboard selector 282 may be selected. A leaderboard signal is communicated to the system server and a leaderboard may be communicated in response thereto.

In FIG. 2I the process for selecting a fantasy team and wagering may be performed by multiple views using respective user devices. During the course of the co-watching session, viewers can access a fantasy team leaderboard 284 that is a wager status display and shows them how their fantasy team is performing against everyone else. The DFS teams of others may be displayed once the selection process is performed, and the competition is closed. This is a live leaderboard that updates in real time from the host server based on a trigger event such as a team or player scoring.

In FIG. 2J, as the match progresses and a viewer's team earns points, message signals may be received from a chatbot 286 in a message window 288 that gives them updates regarding their team's performance.

As shown in the screen display of FIG. 2K, once there is a winner for the wager, that person, in addition to everyone else that was participating in the wager competition, is notified. An example of a notification window 290 communicated to and displayed at a user device is set forth.

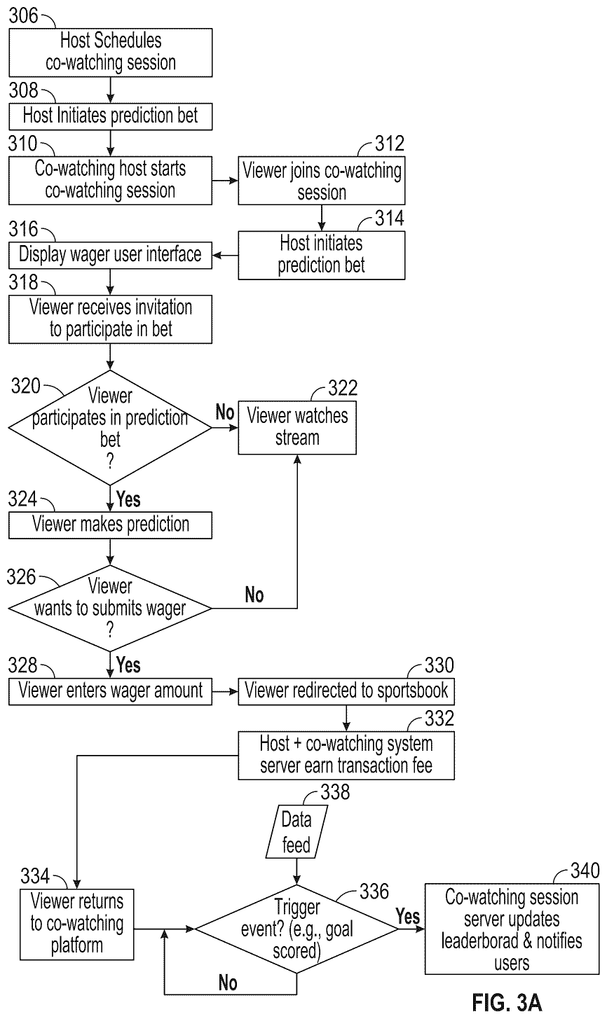

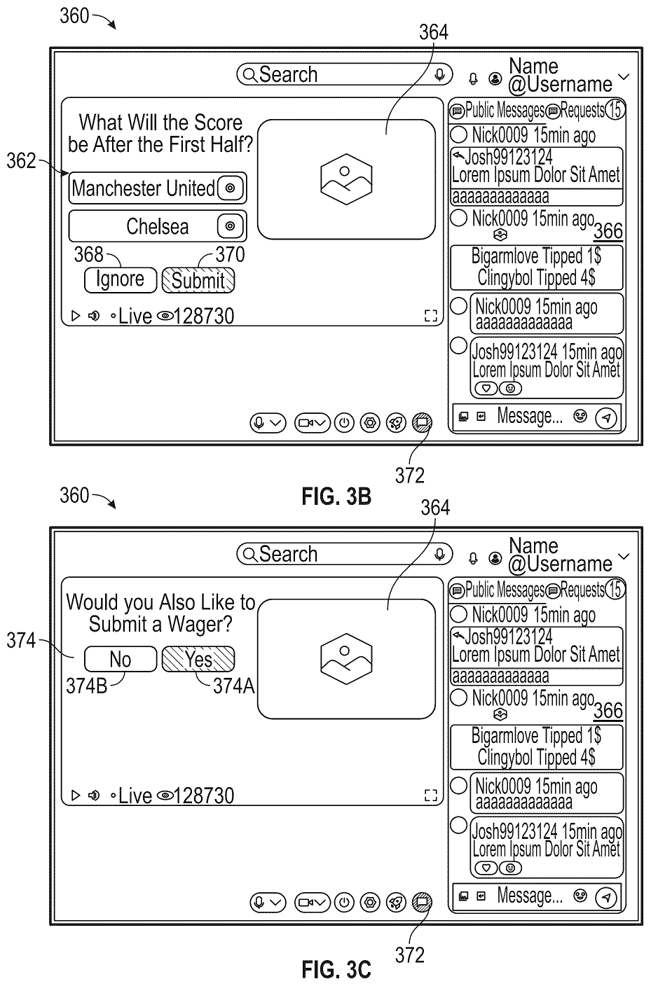

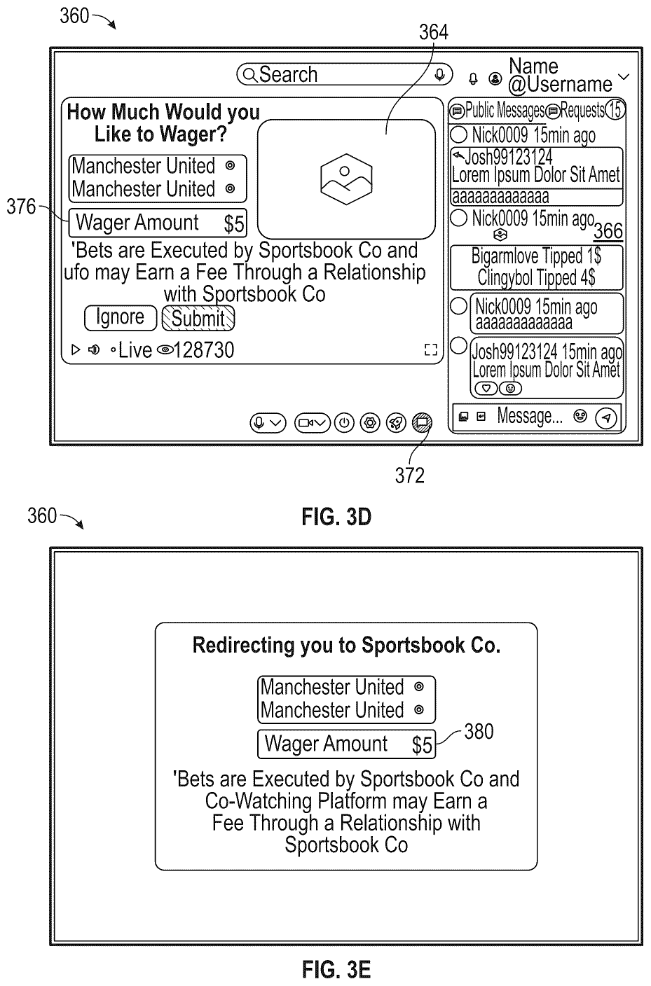

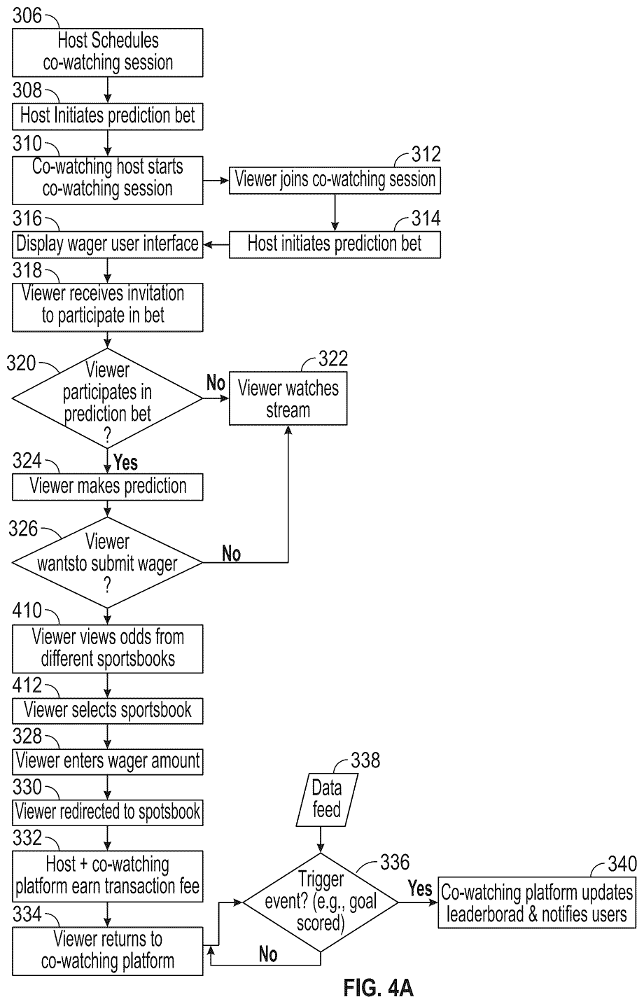

Referring now to FIG. 3A, a flowchart of a method of wagering when the host has a single sportsbook partner is set forth. The screen display descriptions are set forth below starting in FIG. 3B.

In step 306, a co-watching session is initiated. In step 308, a prediction bet may be initiated or later initiated after the co-watching session is live as shown below in step 314. In step 310, the co-watching host starts a co-watching session. In step 312, the viewer with their user devices joins the co-watching session. In step 314, the host initiates a prediction bet. In step 316, a display on the user device displays a wager user interface. The wager user interface is communicated as data to the user device from the system server through a network. In step 318, the viewer receives an invitation to participate in a bet. In step 320, when the viewer does not participate in the prediction bet, step 322 allows the viewer to watch the stream of the co-watching session. Referring back to step 320, when the viewer participates in the prediction bet, step 324 allows the viewer to make a prediction and step 326 provides a query as to whether the viewer wants to submit a wager. If the viewer does not want to submit a wager in step 326, step 322 allows the viewer to co-watch the stream. In step 326, when the viewer does want to submit a wager, step 328 allows the viewer to enter a wager amount by communicating a wager signal to the system server. In step 330, the viewer may be redirected to a sportsbook that may or may not be associated with the system server. In step 332, the host and the co-watching server may earn a transaction fee redirected back from the sportsbook. That is, a commission or the like may be received for the use of the platform. In step 334, the viewer returns to the co-watching platform after placing the wager. In step 336, when a trigger event is not performed, step 336 is repeated. A trigger event may be, for example, a gold score. Determining a trigger event is determined from receiving data from a data feed in step 338. In step 336, if a trigger event is performed, step 340 allows the co-watching platform to update the leaderboard and users may be notified of the results of the wager using data signal communicated from the system server at the end of the streaming event.

Referring now to FIG. 3B, during a live stream or prior to it starting, streamers can create interactive polls that ask viewers to answer questions related to the sports match. Some of these questions may also be wagers that can be found on a sportsbook. In this example, a screen display 360 has an interactive poll area 362. The screen display also has a co-watching area 364 and a chat area 366. These areas are common through FIGS. 3B-3D. A virtual button 368 for ignoring and a virtual button for submitting an answer to the poll is provided. The poll may be reached by activating a button 372 displayed at the bottom of the screen display 360. In the present example, the poll is “What will the score be after the first half”.

Referring now to FIG. 3C, viewers who respond to the question on the screen will be prompted with other questions asking them if they would like to place a wager using their answer for the question in a wager query box 374.

Referring now to FIG. 3C, viewers who respond to the question on the screen will be prompted with other questions asking them if they would like to place a wager using their answer for the question in a wager query box 374. Specifically, a wager query box 374 is generated in place of the poll 362. The wager query has a yes selection 374A and a no selection 374B. If a yes selection is selected, an amount area 376 may be displayed as illustrated in FIG. 3D.

Referring now to FIGS. 3D and 3E, if viewers answer yes to the question related to wagering, the host server will take their wager information and communicate it with a sportsbook partnered with the host server.

The viewer will be redirected to the sportsbook in a new window with a sportsbook direction window 380. The wager information will be communicated through a network and pre-populated in the respective sportsbook (if the viewer already has an account with the sportsbook). If a viewer decides to execute the wager on the sportsbook from the host server, the host server will earn a fee from the sportsbook. The host server will also earn a fee if the viewer does not already have an account with the respective sportsbook and decides to create one after being redirected by the host server.

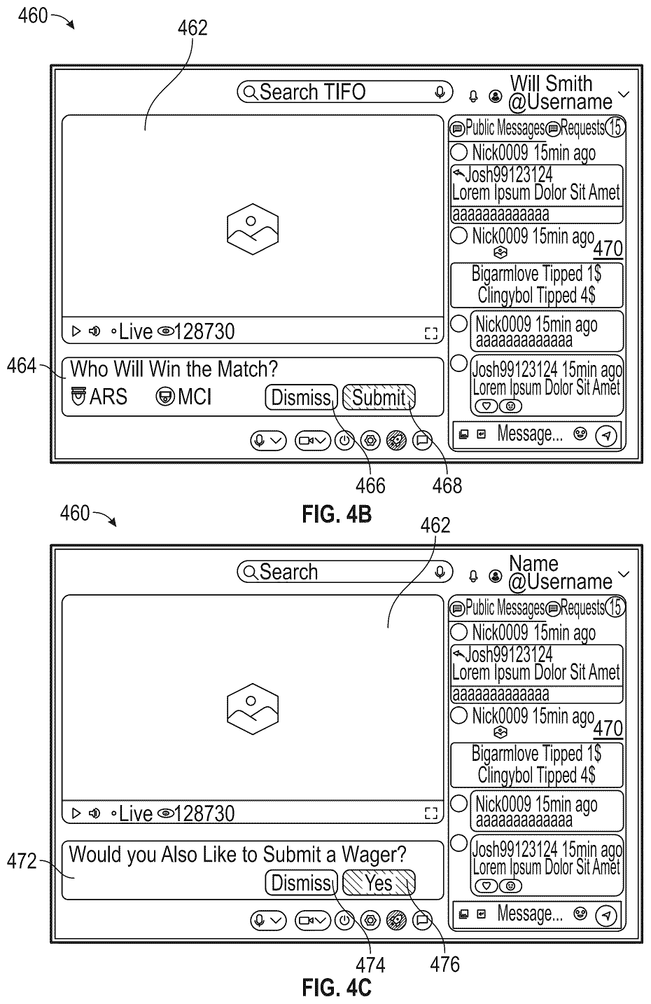

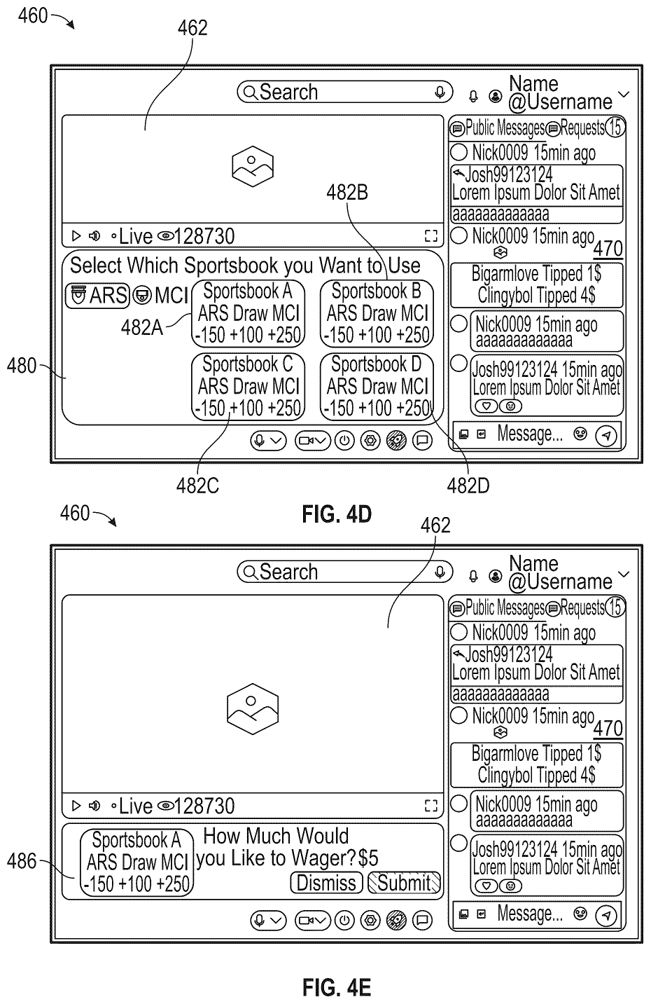

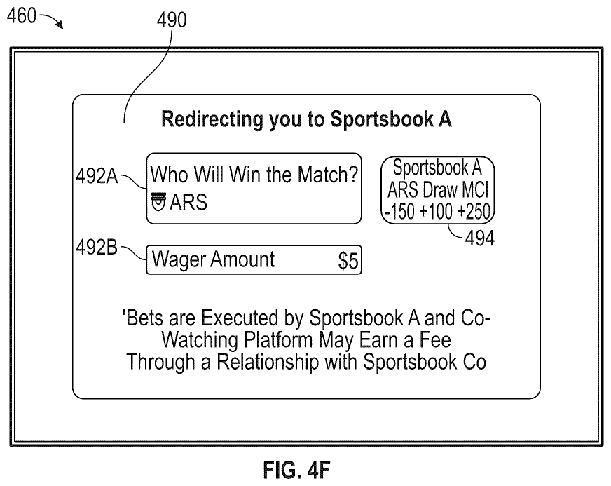

In FIGS. 4A-F, the process for multiple sportsbooks partnered with the host server is similar to the previous idea where the host service provider earns a fee for providing order flow to the different sportsbooks. The main difference here is that the host server does not have an exclusive relationship with one sportsbook. Instead, the host server presents the best odds available to a viewer and allows them to choose which sportsbook they want to place their wager in. The users may view different odds for different wagers in one view.

In this example, the same reference numerals for the same steps illustrated in FIG. 3A are provided with the same reference numbers and will not be described in greater detail. In this example, the system server generates the query as to whether the viewer wants to submit a wager from the user device in step 326. That is, steps 306-326 are identical to that described above in FIG. 3A. After step 326, odds may be obtained from different sports services or “sportsbooks” in step 410. The viewer may select a sportsbook in step 412 based on the odds. The remaining part of the process in steps 328-340 are identical to that described above with the sportsbook chosen in step 412.

Referring now to FIG. 4B, a screen display 460 is illustrated having a co-watching display area 462. A poll area 464 is generated. The poll area 464 may be dismissed by selecting the dismiss virtual button 466 or submitted with the virtual button 468. A chat area 470 may also be displayed on the screen.

Referring now to FIG. 4B, a wager query area 472 is set forth having a dismiss virtual button 474 or an affirmative button 476. This screen display corresponds to step 326 described above.

In FIG. 4D, a sportsbook selection area 480 is illustrated. In this example, four different sportsbook are illustrated with virtual buttons 482A, 482B, 482C and 482D. Data may be communicated to populate each of the selection buttons 482A-482D such as odds. The odds may be different and by selecting the desired button 482A-482B, FIG. 4E may be initiated in which a wager area 486 is displayed to determine how much of a wager may be placed.

In FIG. 4F, a redirection window 490 is displayed that provides selection buttons 492A and 492B that correspond respectively to the poll question and an amount to wager. A display area 494 is set forth that illustrates the sportsbook that was selected.

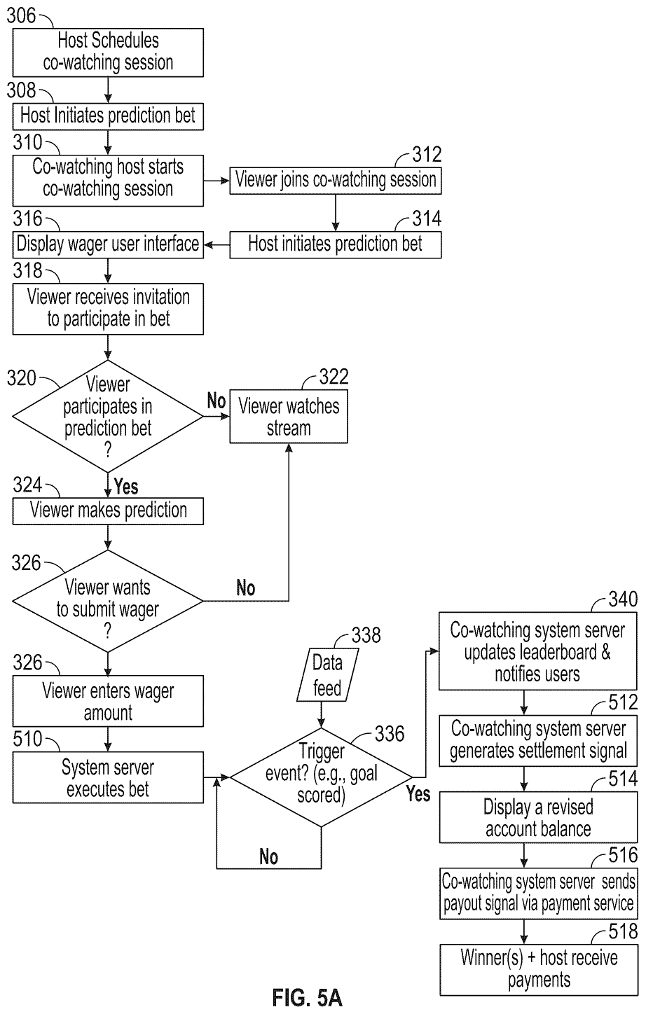

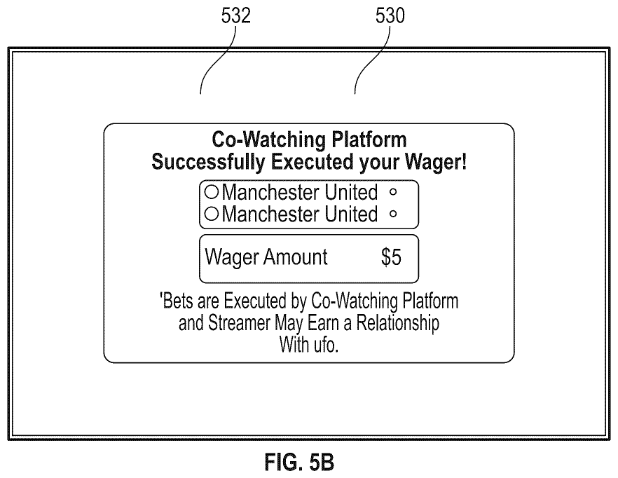

In FIGS. 5A-5B, instead of routing bets to other sportsbooks, the host server (or the platform) acts as the sportsbook and executes all orders that viewers place. Streamers or client devices earn an affiliate fee from the host server for any wagers that are placed in their streams. For any viewer that has placed wagers from or inside the host server, they can view a leaderboard that shows them how their wagers are performing compared to other viewers in a particular stream.

Steps 306-326 are the same as that described in FIG. 3A in that all of the steps up to the viewer entering a wager amount in step 326 are performed identically. However, as mentioned above, the co-watching session server may be used for executing the bet in step 510. That is, data in data signals may be exchanged in the similar manner to that described above for confirming an amount of a wager. Thereafter, steps 336-340 are the same as illustrated in FIG. 3A in which the co-watching session server updates the leaderboard and notifies users in step 340. Thereafter, step 512 allows the session server to generate a settlement signal and a revised or increased account balance is displayed at step 314 for each of the user devices that have won the bet. In step 316, the co-watching session server sends a payout signal via a payment service and the winners plus the hosts receive payments.

Referring now to FIG. 5B, the process and screen displays for executing a bet may be identical to those illustrated in FIGS. 3B-3D. However, a screen display 530 for the co-watching platform or system server is illustrated at the confirmation display 532.

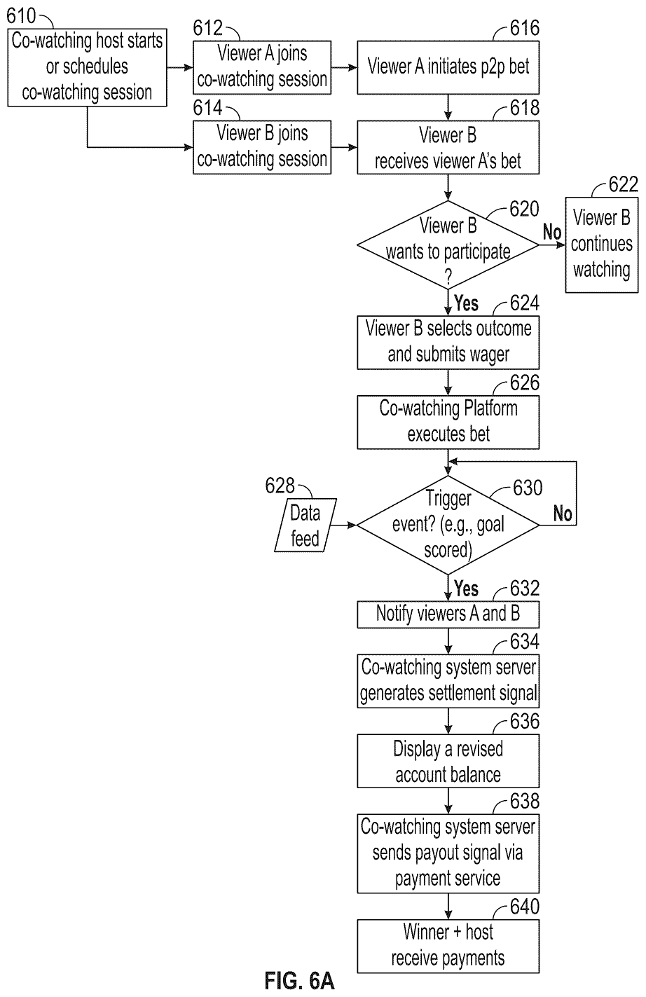

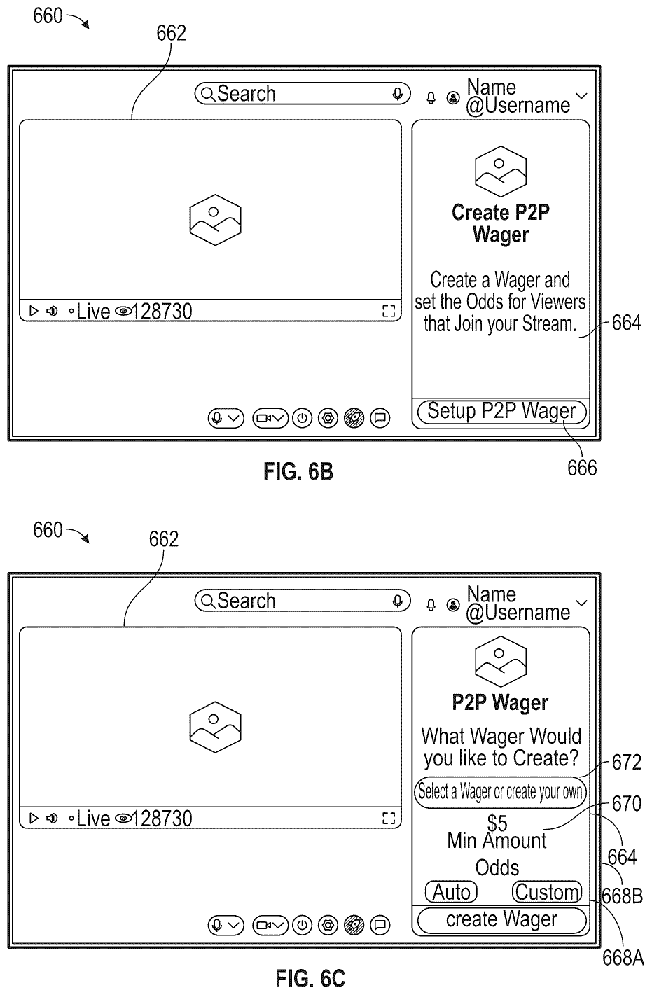

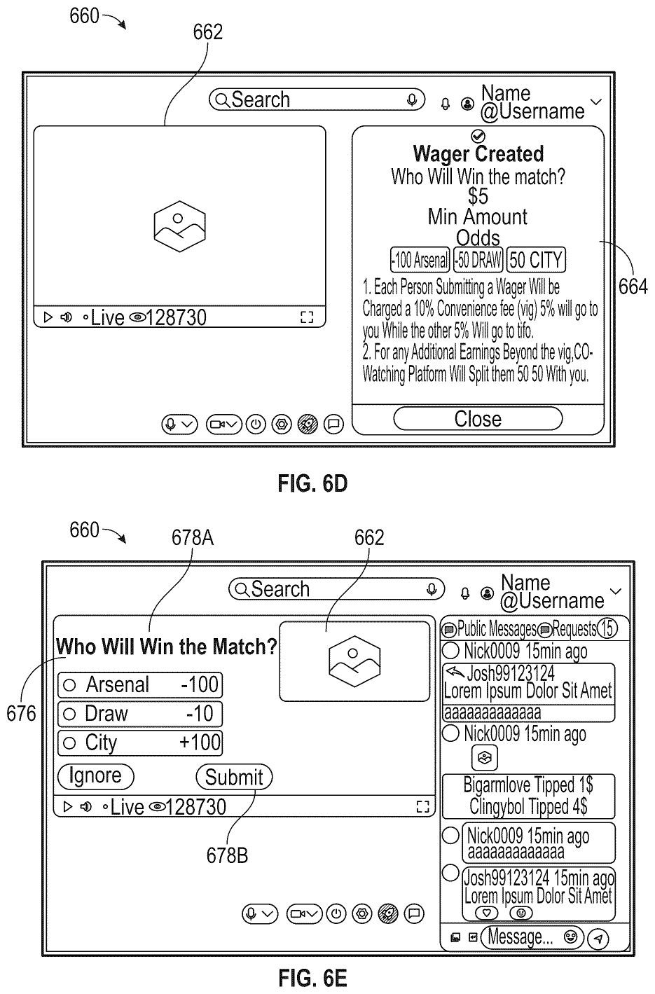

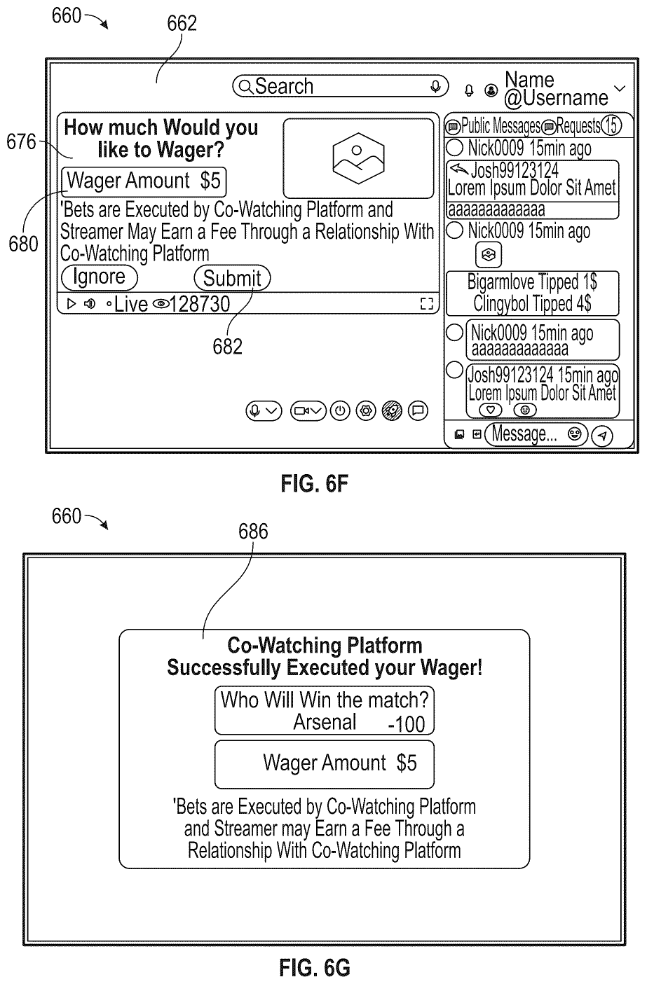

Referring now to FIGS. 6A-6G, the method for peer to peer wagering is set forth. In step 610, a co-watching host starts or schedules a co-watching session from a host device 20 interacting with a system server 12. A user device and the viewer associated therewith joins the co-watching session in step 612. The user device associated with Viewer B joins a co-watching session in step 614. The joining steps of 612 and 614 are optional if the co-watching session was merely scheduled but not started or may be performed after bets are placed. This allows bets to be conveniently placed before the co-watching session goes live as mentioned above A viewer A initiates a person-to-person (p2p) bet. In step 618, viewer B receives viewer A′s bet. In step 620, viewer B is queried as to whether they would like to participate in the bet. If viewer B does not want to participate, step 622 allows viewer B to continue watching the co-watching session. In step 620, when viewer B wants to participate in a bet with viewer A, viewer B selects the outcome and submits a wager. In step 626, the co-watching session may be used to execute the bet. In step 628, data is communicated from a data feed to the system server and step 630 uses the data from the data feed to determine whether a trigger event has occurred. When a trigger event has not occurred, step 630 is repeated. In step 630, when a trigger event has occurred, both viewer A and viewer B are notified in step 632. In step 634, the co-watching system server generates a wager settlement signal and in step 636, a display is revised with a revised account balance for each account involved. In step 638, the co-watching system server sends out a payout signal by way of the payment service such as the system server itself. In step 640, the winner plus the host may receive payments in a similar manner to that described above.

In FIG. 6B, instead of relying on sportsbooks to create or execute wagers, co-watching session participants of viewers are able to create wagers options and bet directly with others. In this model, the viewers act as sportsbooks in a peer to peer model without any reliance on an external sportsbook. (such as 70A-70n) A screen display 660 is illustrated with a co-watching display area 662. A P2P wager area 664 is provided on the right side of the screen in this example. A set up virtual button 666 may be used to enter the P2P wagering process once the selection button 666 is selected.

In FIG. 6C, the wager formation area 664 is changed and viewers can create a wager modeled off what other sportsbooks are offering or completely make up their own custom wager from inside the host server. A viewer creating a wager option inside the live stream experience with the area 662 displayed, other sections of the host server experience may be used. Streamers may also create odds using the custom odds button 668A, or automatically generate odds by using the host server's model using the auto odds generator button which searches different sportsbooks across the internet to determine the best odds to offer for a particular wager. Streamers are also able to set a minimum amount a viewer must wager at the selector button 670. A wager selector button 672 for selecting or creating a wager is set forth.

In FIG. 6D the wager area 664 changes to indicate a wager is created after the specific data in FIG. 6C is selected and communicated to the system server. The wager summary data including the bet description, minimum wager amount and the odds are set forth. For wagers that are placed by viewers, there is a transaction fee commonly known as a vig. Some fraction of the vig will go to the host server as a fee signal, while the other fraction will go to the viewer establishing the wager. The specific split itself may change over time.

In addition, for any additional earnings that occur outside of the vig, the earnings are split between the host server (the platform) and the viewer that is creating the wager option.

In FIGS. 6E-6G, during or before a livestream, viewers are able to view any wagers the streamer may have created in a wager joining area 676. For those interested (and legally able to), a wager may be placed by communicating wager data directly through the host server using any of the payment methods previously described.

Viewers may be able to see wagers outside of the livestream area 662. This could be in another hosted page or also possibly on a third party website or platform. In FIG. 6E, the wager description 678A and a submission button 678B is provided for making the wager. In FIG. 6F, the wager joining area 676 provides a wager amount selector 680 in which an amount of money or tokens may be selected. A submission button 682 is provided for submitting the wager to the host or system server. The amount of the wager and the data corresponding thereto are communicated to the system server 12. In FIG. 6G, a wager success window 686 provides a message that the wager has been successfully executed.

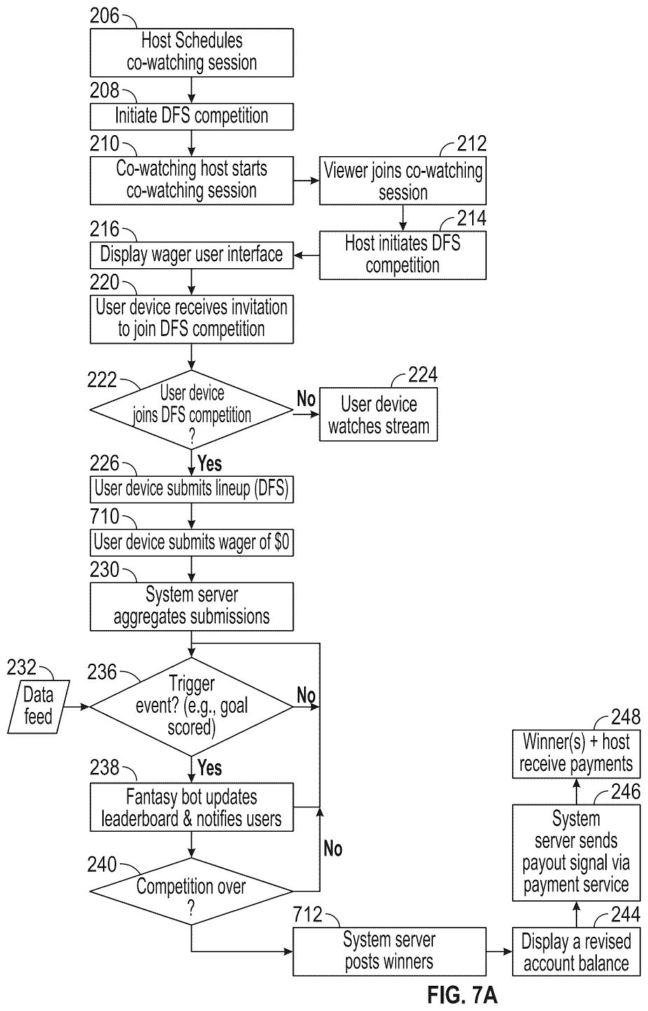

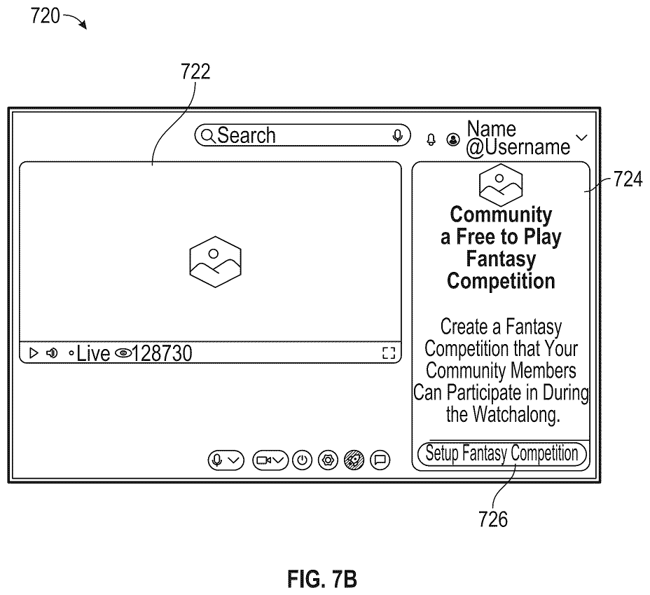

Referring now to FIGS. 7A-7B, streamers have the ability to create a free to play DFS competition that does not have any monetary requirements for participation. Rather points or tokens may be wagered. The points or tokens may allow a winner to be determined. This is essentially the same as the previously outlined DFS competition except there is no entrance fee to join the competition and there is no monetary reward for winning the fantasy competition.

The free play option illustrated in FIG. 7A is identical to that set forth in FIG. 2A except for the noted changes below. Step 228 has been removed and replaced with step 710 in which a zero point or dollar amount is used for the wager. This may be automatically filled in when entering the free to play daily fantasy sports process. The other difference between FIG. 2A and FIG. 7A is that steps 242-248 are no longer required since they are directed toward the settlement of the wagers and the account balances. In FIG. 7A, after the competition is over in step 240, the system server 712 post the winners.

In FIG. 7B, a screen display 720, having a co-watching session 722, may have a free to play fantasy competition area 724 that has a fantasy competition set up button 726 thereon for setting up a free to play fantasy competition.

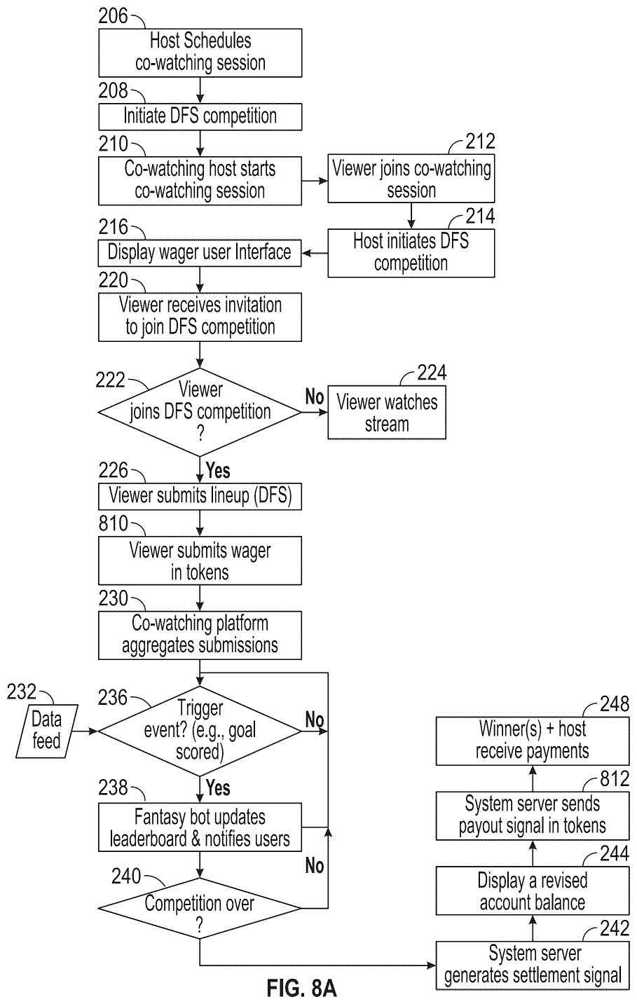

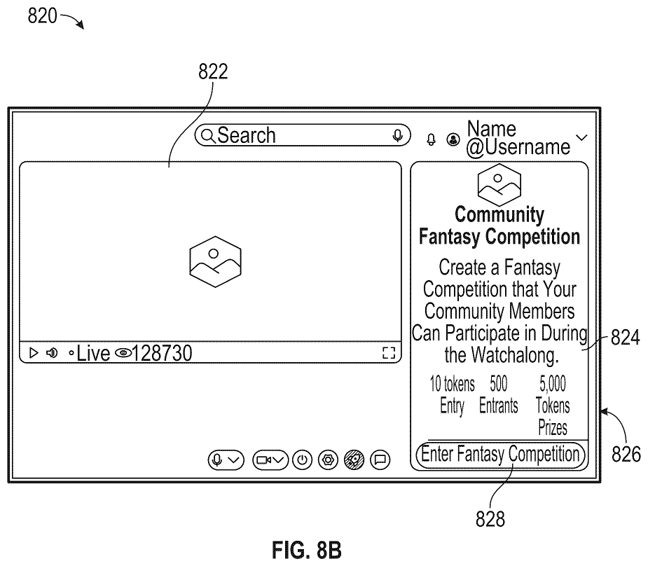

Referring now to FIG. 8A-8B, users may also participate in DFS competitions on the platform using a native token of the platform. This is a virtual currency that could be native to the platform, or it could also be a cryptocurrency that the host server may want to create in the future. In order to participate, users would need to use this virtual currency to participate in the fantasy competition.

Any prizes from winning the competition would also be rewarded in the aforementioned virtual currency.

The virtual currency may be acquired through performing actions on the host server platform, or it may be purchased. In FIG. 8A, the process is identical to that illustrated in FIG. 2A and therefore the common steps will not be repeated. However, in this example, the wager submitted in step 228 has been replaced with step 810 in which tokens are submitted for the wager. Also, step 246 has been replaced with step 812 in which the payment signal is communicated from the system server in tokens rather than a monetary amount. In FIG. 8B, a screen display 820 is illustrated with a co-watching area 822 which is optional. A community fantasy competition area 824 has a limitation area 826 that shows the number of tokens for entry, the maximum number of entrants and the number of tokens for prizes. In this example, ten tokens are needed for entry, a maximum of 500 entrants are provided for and 5,000 tokens are available for prizes in the area 826. A selection button 828 is provided for entering the process which follows the same process and screen displays illustrated in FIGS. 2B-2K except for tokens replace the dollar amounts.

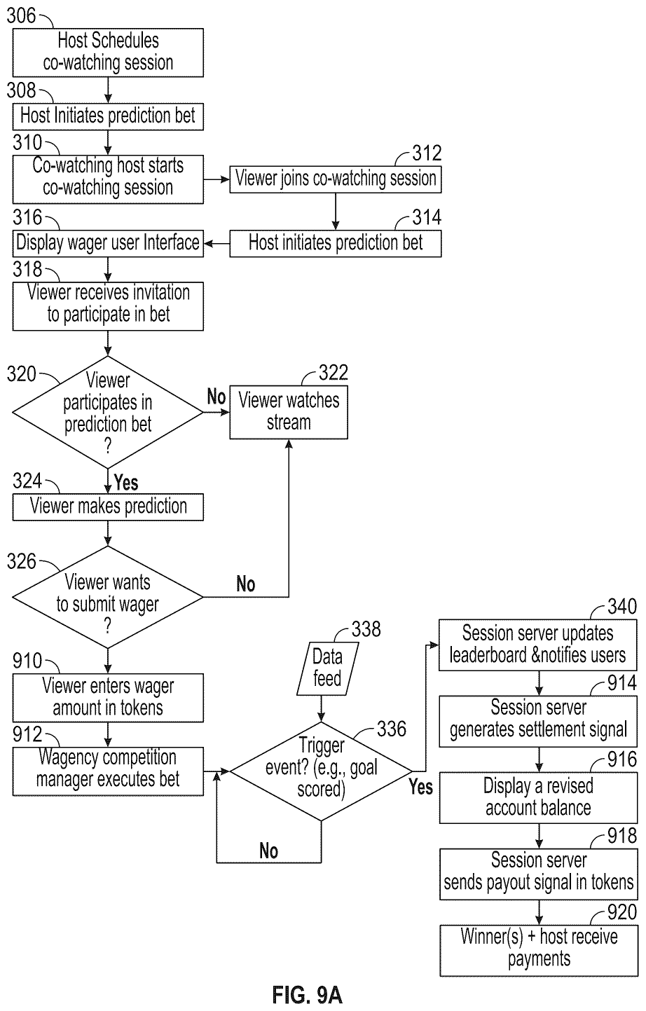

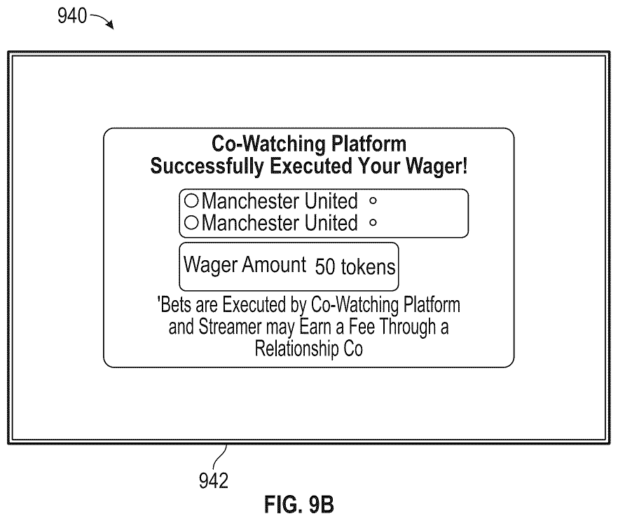

Referring now to FIGS. 9A-9B, the ability to place wagers on the host server platform using a virtual currency may also be offered (similar to how virtual currency is used in the DFS use example of FIG. 3A). The same reference numerals of FIG. 3A are used in FIG. 9A because the process is similar. Step 328 is revised to step 910 in FIG. 9A in which the wager amount is in tokens. In step 912, when the wagering competition manager of the system server executes the bet. Steps 336-340 are identical. After step 340, the session server generates a settlement signal in step 914. A revised account balance is displayed in step 916 for each of the user devices. In step 918, the session server sends out a payment signal in tokens. The winners and the host receive payment in step 920.

In FIG. 9B, a screen display 940 is set forth having a successful wager area 942 that indicates the number of tokens in the wager, the wager and other data may also be displayed.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python.

What is claimed is:

1. A method comprising:
establishing a co-watching session at a host device for a streaming event;
joining the co-watching session at a first user device;
joining the co-watching session at a second user device;
establishing a first account balance associated with the first user device;
establishing a second account balance associated with the second user device;
initiating a wager display interface for a wager during the co-watching session;
generating a selection signal for selecting the wager at the second user device; and
reducing the second account balance based on the selection signal.

2. The method of claim 1 wherein initiating the wager display interface comprises initiating the wager display interface with the host device.

3. The method of claim 1 further comprising joining the co-watching session before the streaming event.

4. The method of claim 1 further comprising joining a competition before the streaming event and before generating the selection signal.

5. The method of claim 1 further comprising receiving a first video signal at the first user device not through the co-watching session and a second video signal at the second user device not through the co-watching session.

6. The method of claim 1 further comprising communicating a wager settlement signal after the streaming event and increasing the second account balance.

7. The method of claim 1 further comprising communicating a wager settlement signal to the second user device after the streaming event and increasing the second account balance in response to the settlement signal to form a revised account balance, and further comprising displaying the revises account balance in the co-watching session.

8. The method of claim 1 wherein the first account balance and the second account balance comprise money, points or tokens.

9. The method of claim 1 wherein initiating the wager display interface comprises initiating a first wager at the first user device and further comprising selecting a first fantasy team at the wager display interface and initiating a second wager at the second user device and further comprising selecting a second fantasy team at the wager display interface.

10. The method of claim 9 further comprising generating a wager status display generating a status for the first wager and the second wager.

11. The method of claim 10 further comprising generating a trigger event based on the streaming event and updating the wager status display based on the streaming event.

12. The method of claim 1 wherein generating a wager status display comprises generating a fantasy team leaderboard during the streaming event in the co-watching session.

13. The method of claim 12 further comprising generating a payout signal based on the leaderboard after an end of the streaming event.

14. The method of claim 1 wherein establishing the co-watching session comprises initiating the co-watching session from the first user device acting as the host device.

15. The method of claim 14 wherein initiating the wager display comprises initiating the wager display from the host device.

16. The method of claim 15 wherein generating the selection signal comprises generating the selection signal from the second user device and further comprising communicating the selection signal to a sportsbook server.

17. The method of claim 16 wherein reducing the account balance comprises reducing the account balance at the sportsbook server.

18. The method of claim 17 further comprising generating a fee signal to the host device based on the reducing the account balance.

19. The method of claim 18 wherein initiating the wager display comprises initiating the wager display at a plurality of user devices.

20. The method of claim 1 wherein generating the selection signal for selecting the wager comprises generating the selection signal from the second user device, displaying a sportsbook display comprising odds from a first sportsbook server and a second sportsbook server, and generating a sportsbook selection signal corresponding to a selected sportsbook server and the user device communicating a wager signal to the selected sportsbook server.

21. The method of claim 1 wherein initiating the wager display comprises initiating the wager display from the first user device and wherein generating a selection signal for selecting the wager at the second user device.

22. The method of claim 1 further comprising selecting odds from the first user device and accepting the odds at the second user device based on the selection signal.

23. The method of claim 22 further comprising generating a fee signal to the host device based on the selection signal.

24. The method of claim 23 further comprising generating a settlement signal to the first user device and the second user device corresponding to the wager after the streaming event.
